(19) United States
(12) Patent Application Publication
(10) Pub. No.: US 2013/0282992 A1
(43) Pub. Date: Oct. 24, 2013

(54) OBJECT-AWARE STORAGE

(71) Applicants: Michael P. Mesnier, Scappoose, OR (US); Shekhar Y. Borkar, Beaverton, OR (US); Mesut A. Ergin, Portland, OR (US)

(72) Inventors: Michael P. Mesnier, Scappoose, OR (US); Shekhar Y. Borkar, Beaverton, OR (US); Mesut A. Ergin, Portland, OR (US)

(73) Assignee: Intel Corporation, Santa Clara, CA (US)

(21) Appl. No.: 13/976,582

(22) PCT Filed: Dec. 22, 2011
(86) PCT No.: PCT/US2011/066893

§ 371 Date: Jun. 27, 2013

(51) Int. Cl. G06F 3/06

(52) U.S. Cl. CPC G06F 3/0604
USPC 711/154

(57) ABSTRACT

A storage unit may have an associated processor and storage controller. The storage controller associated with the storage unit may store a mapping of objects (i.e., data) to blocks in the storage unit. This mapping may be received from another source, such as a file system, database, or software application, among other possibilities. The processor associated with the storage unit may execute operation s on the objects stored in the storage unit.

### TECHNICAL FIELD

This invention pertains to storage, and more particularly to storage coupled to processors.

### BACKGROUND

For a long time, a major problem with computer architecture has been getting data to and from the central processing unit (CPU) to be operated on. Whether the data comes from a storage point (e.g., a hard drive or memory) or is input to the computer from some source, the task of getting the data to the CPU is slow: often, the reason a CPU is idle is because it is waiting for data. This problem is commonly known as the “Von Neumann bottleneck”.

Recognizing the problem of the Von Neumann bottleneck, computer manufacturers have attempted to design new architectures that avoid the problems of data flow. But the solutions that have been attempted are complex, expensive, and require special machine designs. A need remains for a way to address these and other problems associated with the prior art.

### BRIEF DESCRIPTION OF THE DRAWINGS

Embodiments of the present invention are illustrated by way of example, and not by way of limitation, in the drawings and in which like reference numerals refer to similar elements.

FIG. 1 shows a computer including storage units with coupled processors, according to an embodiment of the invention.

FIG. 2 shows a high-level diagram of the components of the computer system of FIG. 1.

FIG. 3 shows another high-level diagram of the components of the computer system of FIG. 1.

FIG. 4 shows a mapping of objects in storage being provided to a storage controller for a storage unit of FIG. 1.

FIG. 5 shows an operation set for a processor of FIG. 1 coupled to a storage unit.

FIGS. 6A and 6B show examples of Multiple Instruction, Single Data (MISD) and Single Instruction, Multiple Data (SIMD) architectures.

FIG. 7 shows a flowchart of a procedure for using a storage unit with a coupled processor.

### DETAILED DESCRIPTION

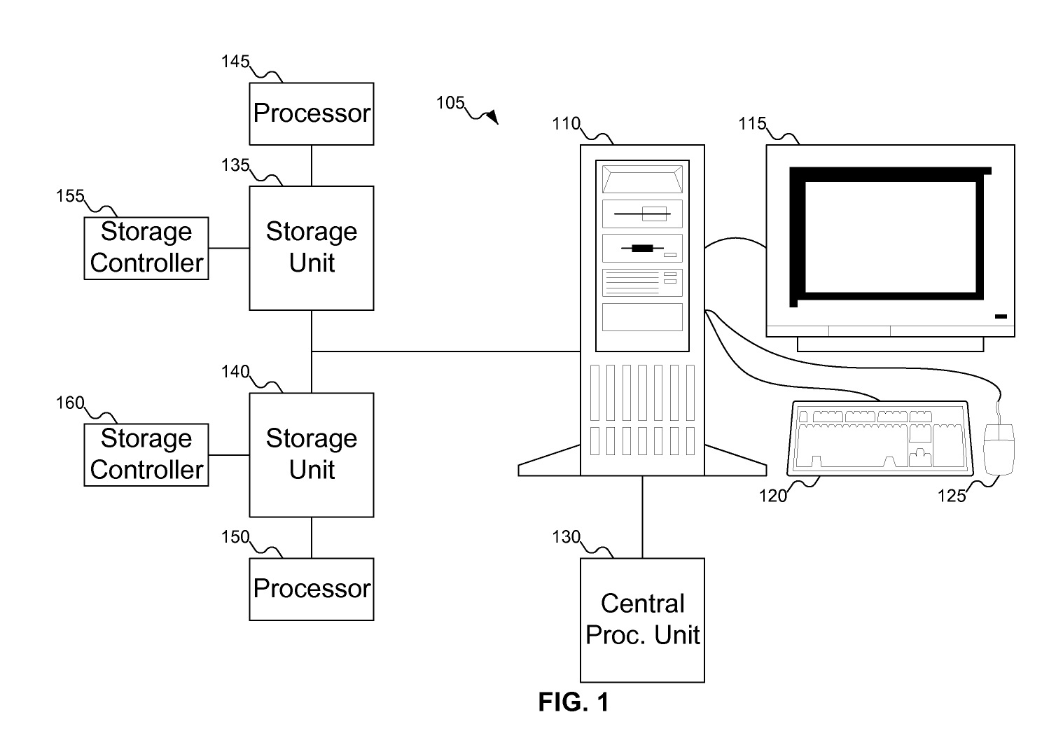

FIG. 1 shows a computer including storage units with coupled processors, according to an embodiment of the invention. In FIG. 1, computer system 105 is shown as including computer 110, monitor 115, keyboard 120, and mouse 125. A person skilled in the art will recognize that other components may be included with computer system 105: for example, other input/output devices, such as a printer.

Computer 110 may include conventional internal components, such as central processing unit (CPU) 130, memory, etc. Computer 110 may include storage units 135 and 140, each of which is coupled to an associated processor 145 and 150 and storage controller 155 and 140. In this manner, each storage unit has its own storage controller 155 and 160 and processor 145 and 150: associated processors 145 and 150 may execute operations on the data stored in associated storage unit 135 and 140. Storage units 135 and 140 may be units of memory, hard disk drives, or any other desired form of storage. Further, different storage units may be of different forms: there is no requirement that all storage units be of the same form.

While FIG. 1 shows two storage units 135 and 140 with associated processors 145 and 150 and storage controllers 155 and 160, a person of ordinary skill in the art will recognize that there may be any number of such storage units; the actual number used may depend on the design and intended usage of computer system 105.

As mentioned above, a “storage unit” is intended to refer to any desired portion of storage. For example, if a storage unit takes the form of a memory module, the memory module may be a Single In-Line Memory Module (SIMM), Dual In-Line Memory Module (DIMM), or any other desired form of memory module. In addition, a “storage unit” may be a portion of a storage module: that is, a single storage module may include multiple storage units. (As each storage unit may have its own associated storage controller and processor, this means that a single storage module may have multiple storage controllers and processors.) If a storage unit includes memory, a storage unit may be made from any desired type of memory, such as Phase Change Memory (PCM), flash memory, Static Random Access Memory (SRAM), Dynamic Random Access Memory (DRAM), or any other desired type of memory. A person of ordinary skill in the art will recognize that a “storage unit” may consist of volatile memory, non-volatile memory, or a combination thereof. A person of ordinary skill in the art will similarly recognize how other forms of storage (e.g., hard disk drives or solid state drives, among other possibilities) may consist of one or more storage units.

Although not shown in FIG. 1, a person skilled in the art will recognize that computer system 105 may interact with other computer systems, either directly or over a network (not shown) of any type. Finally, although FIG. 1 shows computer system 105 as a conventional desktop computer, a person skilled in the art will recognize that computer system 105 may be any type of machine or computing device capable of providing the services attributed herein to computer system 105, including, for example, a laptop computer, a personal digital assistant (PDA), or a cellular telephone.

With the addition of processors 145 and 150 coupled to storage units 135 and 140, respectively, the role of CPU 130 changes. Instead of being responsible for executing operations (e.g., for the operating system, file system, and/or user applications, among other possibilities), CPU 130 becomes more managerial. Specifically, CPU 130 becomes responsible for determining which processor 145 and 150 are to execute specific operations (based, in turn, on what data is affected by those operations). Of course, CPU 130 may continue to execute operations itself as well, whether or applied to particular data objects.

In embodiments of the invention, storage controllers 155 and 160 are responsible for controlling the data in storage units 135 and 140. Storage controllers 155 and 160 may store information about objects stored in storage units 135 and 140. This information, called a mapping, identifies particular objects and the blocks that store those objects.

Processors 145 and 150 may be any variety of processor. Processors 145 and 150 may be single-core or multi-core processors. Processors 145 and 150 may be processors with complex operation sets, or they may be capable of little more than performing read, write, and basic arithmetic operations (for example, an arithmetic logic unit (ALU)). Processors 145 and 150 may also be capable of executing a Java® execution environment, among other possibilities, in which case processors 145 and 150 may be provided software implemented using the Java programming language (Oracle and Java are registered trademarks of Oracle and/or its affiliates.) Finally, different processors coupled to different storage units may have different capabilities, as desired.

An ideal ratio of storage units 135 and 140 (and associated processors 145 and 150) to the overall amount of storage would have each of processors 145 and 150, along with CPU 130, operating without any individual processor or storage unit becoming a bottleneck. But since the burdens that may be placed on processors 145 and 150 and CPU 130 depend on the design and usage of the machine, there is no one “ideal” ratio: different designs and usage models will generally have different “optimal” solutions.

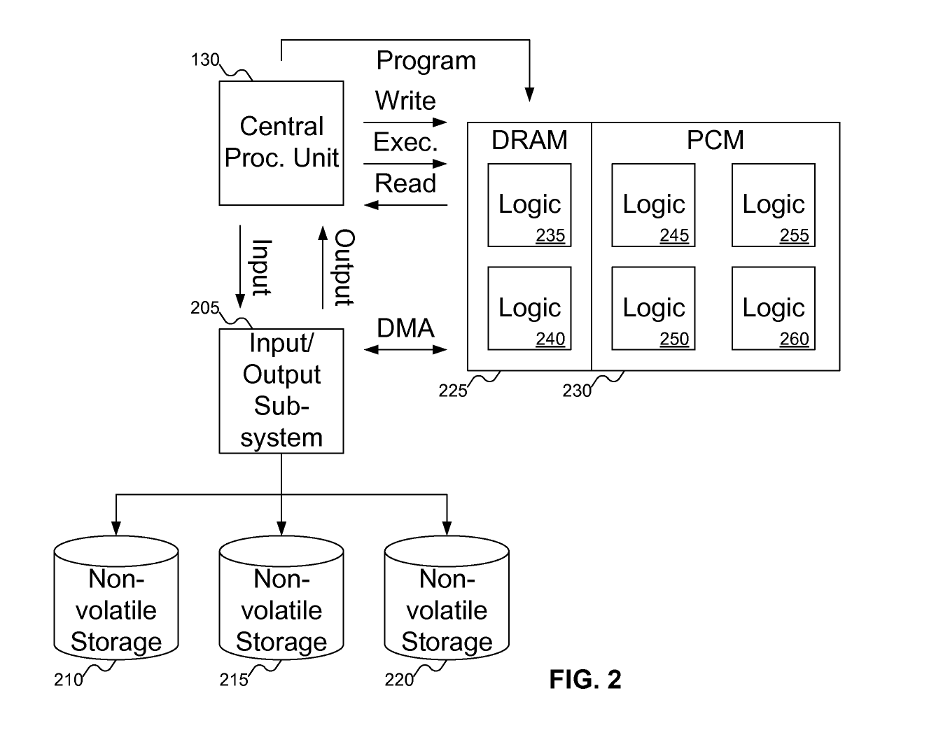

FIG. 2 shows a high-level diagram of components of a computer system, such as the computer system of FIG. 1. In FIG. 2, CPU 130 is shown communicating with Input/Output Subsystem (I/O) 205. I/O 205 is responsible for getting data in to and out of CPU 130. To that end, I/O 205 may access data from non-volatile storage 210, 215, and 220. Non-volatile storage 210 might be an internal hard drive within the computer system, non-volatile storage 215 might be an external hard drive, and non-volatile storage might be storage on a Storage Area Network (SAN): a person of ordinary skill in the art will recognize other possible forms of non-volatile storage. Note that non-volatile storage 210, 215, and 220 may include storage both within and without the computer system. A person of ordinary skill in the art will also recognize that while FIG. 2 shows three different non-volatile storage devices, there may be any number non-volatile storage devices. I/O 205 may also have direct access to DRAM 225 and PCM 230, if needed.

CPU 130 also communicates with DRAM 225 and PCM 230. As discussed above, DRAM 225 and PCM 230 may be memory with coupled processors. FIG. 2 shows that memory modules of different types may be mixed within the computer system: for example, DRAM 225 may be volatile memory and PCM 230 may be non-volatile memory. Logics 235, 240, 245, 250, 255, and 260 represent the combinations of a storage controller and a processor associated with storage units. Note that while FIG. 2 shows only one DRAM 225 and one PCM 230, DRAM 225 includes two logics 235 and 240, and PCM 230 includes four logics 245, 250, 255, and 260. Thus, as discussed above, individual memory modules may be subdivided into storage units, and each storage unit may include its own associated storage controller and processor.

While FIG. 2 describes DRAM 225 and PCM 230 as including storage units, but non-volatile storages 210, 215, and 220 are not described as storage units, a person of ordinary skill in the art will recognize that FIG. 2 is only one possible embodiment of the invention, and that DRAM 225 and PCM 230 might be replaced with other forms of storage with no loss of applicability.

CPU 130 may instruct the various logics 235-260 to write data received from CPU 130, read data into CPU 130, or execute operations. To that end, CPU 130 may provide program operations to logics 235-260 to be executed.

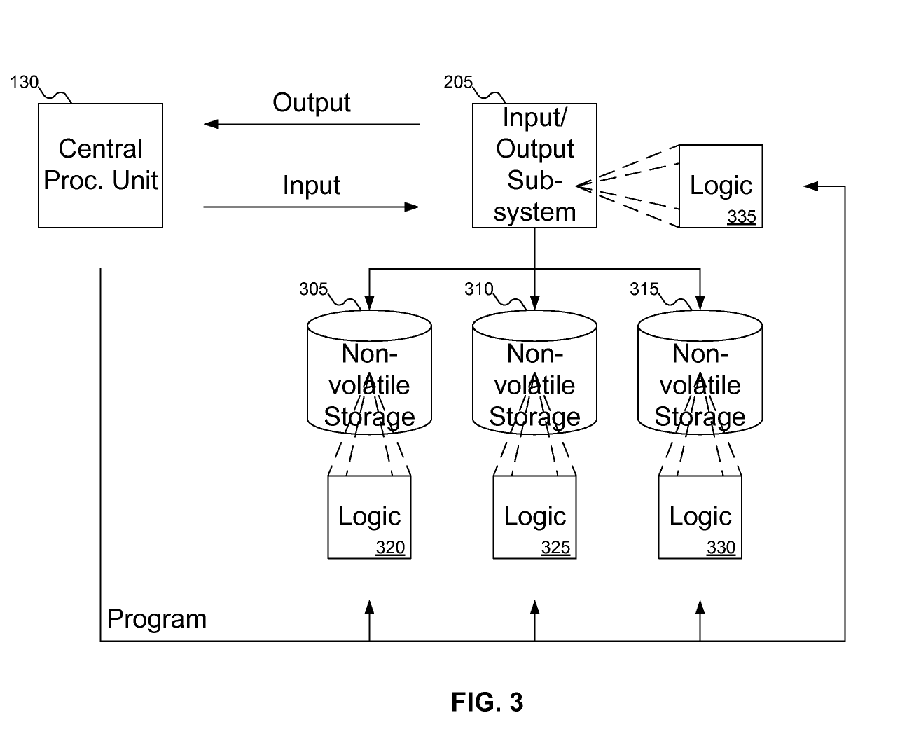

More generally, any storage (volatile or non-volatile) may include logic to support performing operations on objects in the storage. In FIG. 3, CPU 130 and I/O 205 are similar to those in FIG. 2. But non-volatile storages 305, 310, and 315 have logics 320, 325, and 330, that may support performing operations on the non-volatile storages (much as logics 235, 240, 245, 250, 255, and 260 do in FIG. 2). While FIG. 3 only shows one logic per non-volatile storage, a person of ordinary skill in the art will recognize that there may be any number of logics per storage. In addition, I/O 205 may be thought of as storage: for example, I/O 205 might support a Redundant Array of Inexpensive Disks (RAID) configuration. As such, I/O 205 may support logic 335. As shown, each logic 320, 325, 330, and 335 may be programmed to specify operations to perform on the appropriate data.

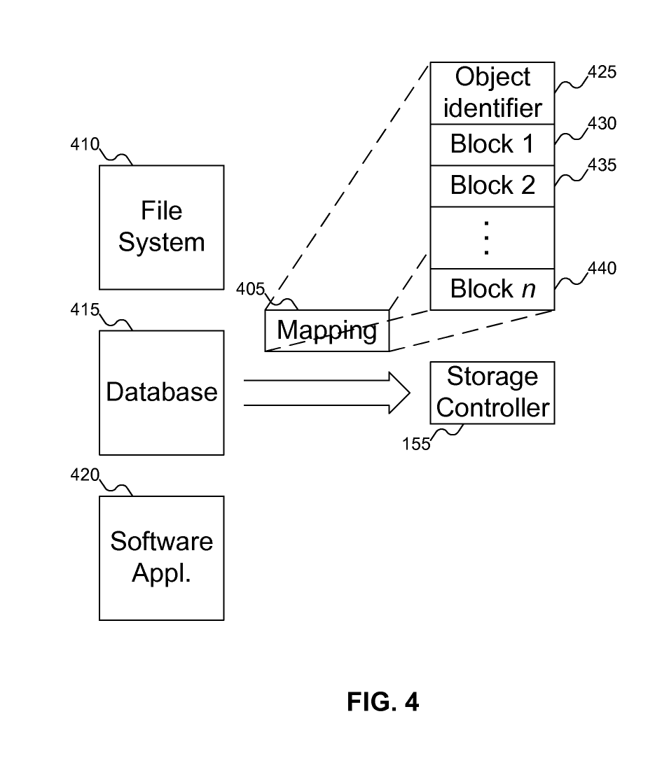

FIG. 4 shows a mapping of objects in storage being provided to a storage controller for a storage unit of FIG. 1. In FIG. 4, mapping 405 is shown being provided to storage controller 155 (the mapping could be provided to any or all storage controllers associated with a particular storage unit, but for simplicity, only storage controller 155 is shown in FIG. 4). Mapping 405 is provided by a source on the computer that is responsible for determining the logical structure of the blocks that make up the storage: this source may be, for example, file system 410, database 415, or software application 420. A person of ordinary skill in the art will recognize other possible sources of mapping 405.

Note that until storage controller 155 receives mapping 405, storage controller 155 does not know what blocks make up specific objects in the storage, or how to interpret those blocks. Mapping 405 provides this information. Mapping 405 may include object identifier 425, which identifies the object in question. Object identifier 425 may also include additional metadata about the object, which may include, among other data, how the file is to be interpreted (e.g., that the file a video clip, a text document, a static image, an audio clip, etc.). Mapping 405 may also specify blocks 430, 435, 440 may make up the object. (The number of blocks that make up the object is not limited to three: any number of blocks may be used.) As it is possible for an object to be fragmented across storage, blocks 430, 435, 440 might not form a continuous portion of storage: that is, blocks 430, 435, 440 might be scattered across the storage, and in no particular order.

A difference between embodiments of the invention as compared with other solutions to the problem of the Von Neumann bottleneck is that storage controller 155 uses information about the data stored in the storage (i.e., mapping 405), but does not control that information. In the prior art, storage controller 155 either did not have access to mapping 405 (in which case operations were performed with less than complete information) or owned mapping 405. But having storage controller 155 own mapping 405—that is, having storage controller 155 be responsible for allocating blocks of storage and knowing what data is stored in what blocks—(a model known as object-based storage model) has drawbacks. Higher level software may make use of mapping 405 as well, and often may map data in a manner that is more useful to the higher level software.

But by having storage controller 155 receive mapping 405 from other sources, embodiments of the invention get the benefit of both alternatives. The storage units continue to use a block-based storage model, so storage manufacturers may use whatever scheme they desire to manage storage, but storage controller 155 may use the information about how the data is organized in storage to best execute operations on that data.

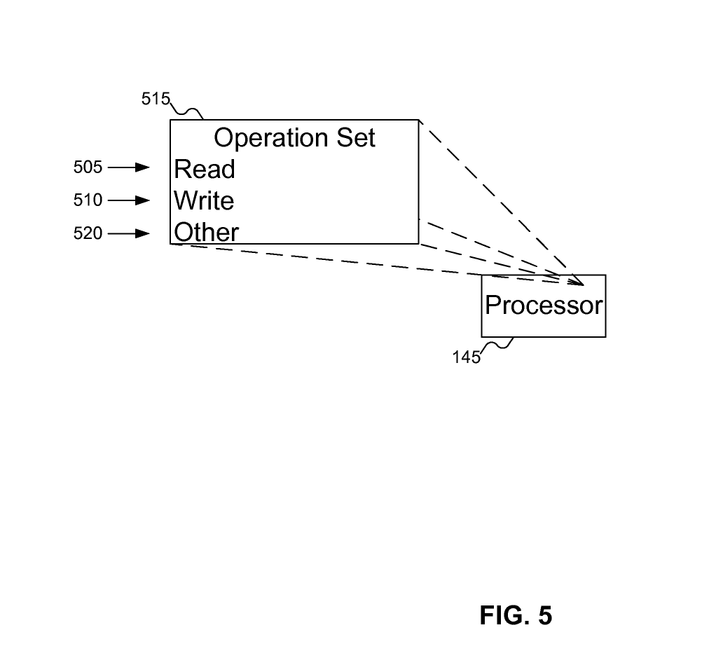

FIG. 5 shows an operation set for a processor of FIG. 1 coupled to a storage unit. In contrast to a “typical” storage system that may only perform two operations—read 505 and write 510—operation set 515 of processor 145 may have additional operations, such as operation 520.

As discussed above, these additional operations may be any desired operations that may be applied to a data object. Processor 145 might only have basic arithmetic and logic operations in addition to read and write operations. Or processor 145 might be capable of executing software written using the Java programming language. In short, processor 145 may be any processor, whether manufactured now, in the past, or in the future. As such, the scope of the additional operations in processor 145 is essentially unlimited.

As discussed above with reference to FIG. 4, the storage controller associated with the storage unit may store the mapping of an object to the blocks in the storage. Using this information, processor 145 may operate on the data at a higher level than might otherwise occur. For example, processor 145 might be executing operations to search a document for a text string. To execute these operations requires knowing the format of the file to be searched. Without knowing the mapping, processor 145 would probably not be able to execute these operations. But by knowing the mapping, processor 145 may execute more complicated operations like searches.

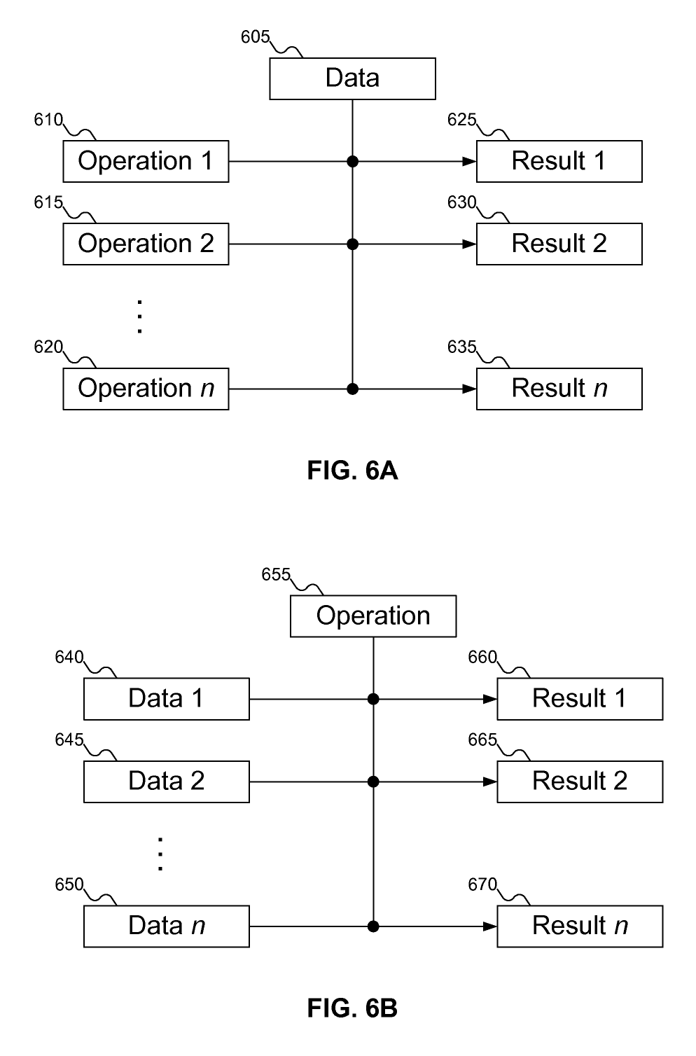

FIGS. 6A and 6B show examples of Multiple Instruction, Single Data (MISD) and Single Instruction, Multiple Data (SIMD) architectures. In FIG. 6A, showing a MISD architecture, data 605 is a single piece of data, which is operated on by each of operations 610, 615, and 620 independently, in different processors. (Although FIG. 6A shows three operations, a person of ordinary skill in the art will recognize that there may be any number of operations.) The results of these operations are results 625, 630, and 635.

A MISD architecture may be achieved using embodiments of the invention, where the same data is copied into the memories associated with different associated processors. Each associated processor may then be given one of operations 610, 615, and 620 to execute on the copy of data stored in the associated storage, thereby producing a single result of the combination of that operation and that data.

In contrast, in FIG. 6B, showing a SIMD architecture, data 640, 645, and 650 are three different pieces of data. (A person of ordinary skill in the art will recognize that there may be any number of pieces of data.) A single operation 655 may be executed on these three pieces of data, producing results 660, 665, and 670.

A SIMD architecture may be achieved using embodiments of the invention, where the same operation is sent to the processors associated with the different data. Each of the associated processors may then produce a single result of the combination of that data and that operation.

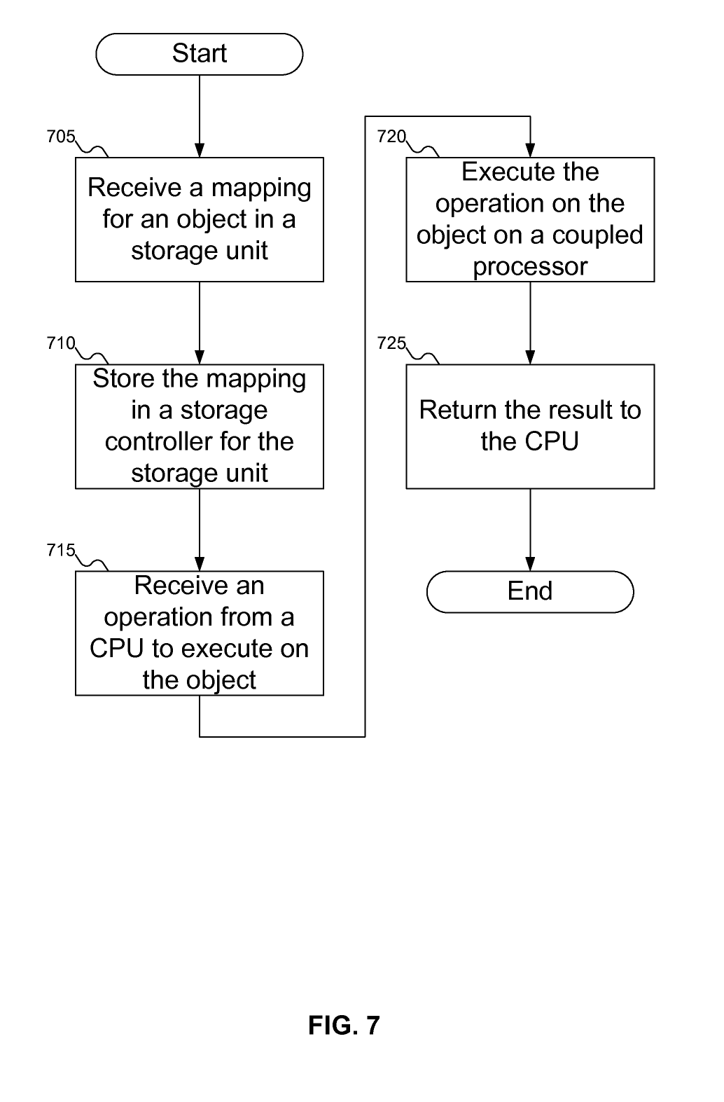

FIG. 7 shows a flowchart of a procedure for using a storage unit with a coupled processor. In FIG. 7, at block 705, a mapping for an object stored in a storage unit is received.

At block 710, this mapping is stored in the storage controller associated with the storage unit. At block 715, an operation to be executed on this object is received. At block 720, the processor associated with the storage unit executes the operation. As discussed above with reference to FIGS. 4-5, executing the operations may utilize the mapping of the object to blocks in the storage unit. Finally, at block 725, the result of executing the operations may be returned to the CPU.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, any of the Institute of Electrical and Electronics Engineers (IEEE) 810.11 standards, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc.: such associated data, by virtue of being stored on a storage medium, does not include propagated signals. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. An apparatus, comprising:
a plurality of storage units;
for each storage unit, a processor coupled to the storage unit, the processor capable of executing at least a read operation, a write operation, and a third operation; and
for each storage unit, a storage controller capable of managing an object in the associated storage unit,
wherein each storage controller receives a mapping about said object in the associated storage unit from a source on a machine, said mapping including an indication of a set of blocks for said object in said storage unit.

2. An apparatus according to claim 1, wherein the plurality of storage units are stored in phase change memory.

3. An apparatus according to claim 1, wherein each processor includes a Java execution environment.

4. An apparatus according to claim 1, wherein at least one processor is a single-core processor.

5. An apparatus according to claim 1, wherein at least one processor is a multi-core processor.

6. An apparatus according to claim 1, wherein at least a subset of the processors are arranged to execute an operation in a Multiple Instruction, Single Data format.

7. (canceled)

8. (canceled)

9. A system, comprising:
a computer;
a central processing unit in the computer;
a plurality of storage units;
for each storage unit, a processor coupled to the storage unit, the processor capable of executing at least a read operation, a write operation, and a third operation; and
for each storage unit, a storage controller capable of managing an object in the associated storage unit,
wherein the central processing unit manages the operations of the processors associated with the storage units, and wherein each storage controller receives a mapping about said object in the associated storage unit from a source on the computer, said mapping including an indication of a set of blocks for said object in said storage unit.

10. A system according to claim 9, wherein the central processing unit is operative to send operations to at least one of the processors associated with the storage units and to receive results from said processor.

11. A system according to claim 9, wherein the plurality of storage units are stored in phase change memory.

12. A system according to claim 9, wherein each processor includes a Java execution environment.

13. (canceled)

14. A system according to claim 9, wherein at least one processor is a multi-core processor.

15. A system according to claim 9, wherein at least a subset of the processors are arranged to execute an operation in a Multiple Instruction, Single Data format.

16. A system according to claim 9, wherein at least a subset of the processors are arranged to execute an operation in a Single Instruction, Multiple Data format.

17. A system according to claim 9, wherein said source is drawn from a set including a file system, a database, or an application.

18. A method, comprising:
receiving from a source on a computer a mapping of an object to a set of blocks in a storage unit of the computer, the storage unit coupled to a processor;
storing the mapping of the object in a storage controller;
receiving from a central processing unit in the computer an operation to execute on the object in the storage unit; and
executing the operation on the object in the storage unit using the processor, using the identifier of the object in the storage controller,
wherein the storage controller does not own the identifier of the object in the storage unit, and wherein the processor is capable of performing at least a read operation, a write operation, and a third operation.

19. A method according to claim 18, wherein:
executing the operation on the object in the storage unit includes producing a result; and
returning the result to the central processing unit.

20. (canceled)

21. A method according to claim 18, wherein executing the operation on the object in the storage unit using the processor includes executing the operation on the object in the storage unit using the processor, where the processor includes a Java execution environment.

22. (canceled)

23. A method according to claim 18, wherein executing the operation on the object in the storage unit using the processor includes executing the operation on the object in the storage unit using the processor as part of a Single Instruction, Multiple Data array.

24. A method according to claim 18, wherein receiving from a source on a mapping of an object to a set of blocks in a storage unit of the computer includes receiving from the source on the computer the mapping of the object to the set of blocks in the storage unit of the computer, where the source is drawn from a set including a file system, a database, and an application.

25. An article, comprising a non-transitory storage medium, said non-transitory storage medium having stored thereon instructions that, when executed by a machine, result in:
receiving from a source on a computer a mapping of an object to a set of blocks in a storage unit of the computer, the storage unit coupled to a processor;
storing the mapping of the object in a storage controller;
receiving from a central processing unit in the computer an operation to execute on the object in the storage unit; and
executing the operation on the object in the storage unit using the processor, using the identifier of the object in the storage controller,
wherein the storage controller does not own the identifier of the object in the storage unit, and wherein the processor is capable of performing at least a read operation, a write operation, and a third operation.

26. An article according to claim 25, wherein receiving from a source on a computer an identifier of an object in a storage unit of the computer includes receiving from the source on the computer the identifier of the object in the storage unit of the computer coupled to a processor, where the storage unit is stored in phase change memory.

27. An article according to claim 25, wherein executing the operation on the object in the storage unit using the processor includes executing the operation on the object in the storage unit using the processor, where the processor includes a Java execution environment.

28. An article according to claim 25, wherein executing the operation on the object in the storage unit using the processor includes executing the operation on the object in the storage unit using the processor as part of a Multiple Instruction, Single Data array.

29. An article according to claim 25, wherein executing the operation on the object in the storage unit using the processor includes executing the operation on the object in the storage unit using the processor as part of a Single Instruction, Multiple Data array.

30. An article according to claim 25, wherein receiving from a source on a mapping of an object to a set of blocks in a storage unit of the computer includes receiving from the source on the computer the mapping of the object to the set of blocks in the storage unit of the computer, where the source is drawn from a set including a file system, a database, and an application.
